(19) United States
(12) Patent Application Publication
(10) Pub. No.: US 2026/0118814 A1
(43) Pub. Date: Apr. 30, 2026

(54) IMAGE FORMING APPARATUS

(71) Applicant: Sharp Kabushiki Kaisha, Osaka (JP)

(72) Inventors: Takahiro TAGUCHI, Sakai City (JP); Yuusuke ITAGAKI, Sakai City (JP); Kouta YOSHIKAWA, Sakai City (JP)

(21) Appl. No.: 19/363,806

(22) Filed: Oct. 21, 2025

(30) Foreign Application Priority Data
Oct. 31, 2024 (JP) 2024-191422

(51) Int. Cl. G03G 15/00; G03G 15/20

(52) U.S. Cl. CPC G03G 15/657; G03G 15/2039; G03G 15/2064; G03G 15/6564; G03G 2215/00405; G03G 2215/00409; G03G 2215/00413; G03G 2215/2045

(57) ABSTRACT

An image forming apparatus includes a transfer device, a fixing device including a fixing belt, a heat source, a pressure roller, and a pressure roller temperature detector, a storage that stores, for each thermal expansion degree in a radial direction of the pressure roller, tables each showing a correspondence between a surface temperature of the pressure roller and an appropriate circumferential speed of the pressure roller, and a processor that acquires, at a start of a printing job, a table from the storage, based on a temperature difference between a surface temperature of the fixing belt and the surface temperature of the pressure roller, refers to the table being acquired to decide the circumferential speed of the pressure roller that corresponds to the surface temperature of the pressure roller.

### CROSS-REFERENCE TO RELATED APPLICATION

The present application claims priority from Japanese Application JP2024-191422, the content of which is hereby incorporated by reference into this application.

### BACKGROUND OF THE INVENTION

### 1. Field of the Invention

The present disclosure relates to an imaging forming device such as a copying machine, a multifunction machine, a printer, or a facsimile machine.

### 2. Description of the Related Art

In an image forming apparatus in the related art that includes a transfer device that transfers a toner image onto a recording material such as recording paper and a fixing device provided with a heat source that fixes the toner image transferred onto the recording material by a fixing member and a pressure roller, the following inconveniences arise.

FIG. 11 is a side view schematically illustrating a part corresponding to a transfer device 11X and a fixing device 12X in an image forming apparatus 100X in the related art.

In the image forming apparatus 100X in the related art, while a conveying speed of the recording material P in the transfer device 11X hardly varies, a conveying speed of the recording material P in the fixing device 12X varies due to temperatures of the fixing member and the pressure roller. The variation range of the conveying speed of the recording material P in the fixing device 12X may reach 2 to 3%. When the conveying speed of the recording material P in the fixing device 12X is higher than the conveying speed in the transfer device 11X, the recording material P conveyed between the transfer device 11X and the fixing device 12X may be pulled by the fixing device 12X to be in a state with less deflection. In such a state, a toner image transferred onto the recording material P rubs against the fixing member of the fixing device 12X or the like, which may cause a transfer failure.

In view of this, in the related art, there has been proposed an image forming apparatus that controls a temperature of the fixing device 12X as appropriate so as to prevent the conveying speed of the recording material P in the fixing device 12X from being higher than the conveying speed in the transfer device 11X. In the conventional image forming apparatus, with regard to a fixing member forming a fixing device, a temperature in a paper passing region through which a recording material passes and a temperature in a non-paper passing region through which the recording material does not pass are detected by respective temperature sensors, and a temperature of a pressure roller constituting the fixing device is predicted based on a temperature difference between the paper passing region and the non-paper passing region. Further, based on the predicted temperature of the pressure roller, a target temperature in temperature control of the fixing member is changed.

In the related art, as another method of preventing occurrence of the transfer failure described above, there has also been proposed an image forming apparatus wherein a thermal expansion degree in a radial direction of a pressure roller is predicted based on a surface temperature of the pressure roller, and a circumferential speed of the pressure roller is reduced based on the prediction result. According to this image forming apparatus, even when the pressure roller thermally expands, the conveying speed of the recording material in the fixing device does not exceed the conveying speed of the recording material in the transfer device, and a deflection amount of the recording material is kept constant. Thus, the occurrence of the transfer failure described above can be prevented in advance.

### SUMMARY OF THE INVENTION

However, in the related-art image forming apparatus in which the circumferential speed is reduced based on the surface temperature of the pressure roller, the thermal expansion degree in the radial direction, in some cases, cannot be estimated accurately based on the surface temperature of the pressure roller, depending on a condition of a printing job (hereinafter, simply referred to as a job). In such a case, there arises a problem that the transfer failure described above occurs because a reduction amount of the circumferential speed of the pressure roller is insufficient, and the recording material is pulled by the fixing device to be in a state with less deflection.

For example, the correspondence between the surface temperature of the pressure roller and the thermal expansion degree thereof differs depending on whether continuous printing is performed or intermittent printing is performed. Therefore, in a case in which a job is started in a state where the thermal expansion of the pressure roller has already progressed, as in intermittent printing, when a reduction amount of the circumferential speed of the pressure roller is decided while assuming continuous printing, the above-mentioned transfer failure occurs due to an insufficient reduction amount.

In view of this, an object of the present disclosure is to provide an image forming apparatus that can suppress occurrence of a transfer failure by accurately estimating a thermal expansion degree of a pressure roller at a start of a job and deciding a reduction amount of a circumferential speed of the pressure roller.

In order to solve the above-mentioned problem an image forming apparatus according to the present disclosure is an image forming apparatus that forms an image being a toner image on a recording material having a sheet-like shape, and includes a transfer device that causes a recording material to be nipped between a transfer nip and transfers a toner image onto the recording material, a fixing device that causes a recording material to be nipped between a fixing nip and fixes the toner image on the recording material, the fixing device including a fixing member that is axially supported to be rotatable, a heat source that heats the fixing member, a pressure roller that forms the fixing nip together with the fixing member and is driven to rotate, and a pressure roller temperature detector that detects a surface temperature of the pressure roller, a storage that stores, for each thermal expansion degree in a radial direction of the pressure roller, a table showing a correspondence between the surface temperature of the pressure roller and an appropriate circumferential speed of the pressure roller, and a processor that estimates, at a start of a printing job, a thermal expansion degree in the radial direction of the pressure roller, based on a parameter different from the surface temperature of the pressure roller, acquires the table from the storage, based on the estimation, refers to the table being acquired to decide a circumferential speed of the pressure roller that corresponds to the surface temperature of the pressure roller that is detected by the pressure roller temperature detector.

According to the present disclosure, occurrence of a transfer failure can be suppressed by accurately estimating a thermal expansion degree of a pressure roller at a start of a job and deciding a reduction amount of a circumferential speed of the pressure roller.

### BRIEF DESCRIPTION OF THE DRAWINGS

FIG. 1 is a cross-sectional view illustrating a schematic configuration of an image forming apparatus according to an embodiment.

FIG. 2 is a perspective view of a fixing device in the image forming apparatus illustrated in FIG. 1.

FIG. 3 is a cross-sectional view taken along the line A-A illustrated in FIG. 2.

FIG. 4 is a perspective view of a part corresponding to an end portion of a fixing belt of a fixing device according to the present embodiment on one side in a rotation axis direction as viewed from the front side.

FIG. 5 is a perspective view of a part corresponding to an end portion of the fixing belt of the fixing device according to the present embodiment on the other side in the rotation axis direction as viewed from the back side.

FIG. 6 is a perspective view of a state in which the fixing belt is supported by one of holding members and the other of the holding members, as viewed from the front side.

FIG. 7 is a schematic block diagram illustrating a control configuration for correcting a value of a transfer bias, based on a detection temperature of a pressure roller in the image forming apparatus.

FIG. 8 is a flowchart illustrating a flow of circumferential speed decision processing for a pressure roller 32 by a processor 60a of a controller 60.

FIG. 9 is an explanatory view illustrating a first table t1 according to the present embodiment.

FIG. 10 is an explanatory view illustrating a second table t2 according to the present embodiment.

FIG. 11 is a side view schematically illustrating a part corresponding to a transfer device 11X and a fixing device 12X in an image forming apparatus 100X in the related art.

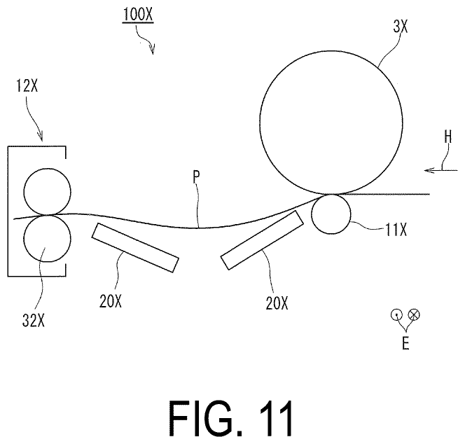

### DETAILED DESCRIPTION OF THE INVENTION

Embodiments according to the present disclosure are described below with reference to the drawings. In the following description, the same components are denoted by the same reference symbols. The names and functions of the components are also the same. Accordingly, detailed descriptions thereof are not repeated.

### Image Forming Apparatus

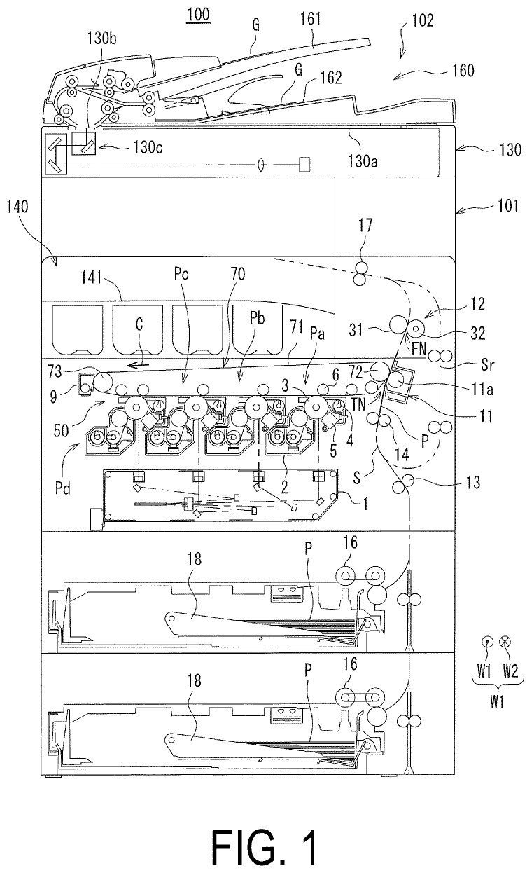

FIG. 1 is a cross-sectional view illustrating a schematic configuration of an image forming apparatus 100 according to the present embodiment.

As illustrated in FIG. 1, the image forming apparatus 100 is a multifunction machine including a copy function, a scanner function, a facsimile function, and a printer function, in which a document G is read by an image scanning device 102, is converted into electronic image data, and transmits the electronic image data to an external device. The image forming apparatus 100 forms a color or single-color toner image on the recording material P such as a recording sheet, based on the image data obtained by converting the document G into the electronic data by the image scanning device 102 or image data received from an external device. The image forming apparatus 100 may be a monochromatic image forming apparatus. The image forming apparatus 100 may be a chromatic image forming apparatus of another form.

A document feeding device 160 (automatic document feeding device) supported in an openable/closable manner with respect to an image scanner 130 is provided above the image scanner 130. The image scanning device 102 scans the document G conveyed by the document feeding device 160. The document feeding device 160 includes a document placement tray 161 on which the document G is placed and a document discharge tray 162 on which the document G after reading is placed. The document feeding device 160 sequentially conveys one or a plurality of the documents G placed on the document placement tray 161 one by one onto a document scanner 130b of the image scanner 130, and discharges the documents G onto the document discharge tray 162. The image scanner 130 includes a document placement table 130a on which the document G is placed. The image scanning device 102 scans the document G placed on the document placement table 130a. In the image forming apparatus 100, when the document feeding device 160 is opened, the document placement table 130a above the image scanner 130 is opened, and the document G can be manually placed thereon. The image scanner 130 scans the document G conveyed by the document feeding device 160 with a scanning optical system 130c positioned at a scanning position below the document scanner 130b, or uses the scanning optical system 130c to scan the document G placed on the document placement table 130a to generate image data.

An image forming apparatus main body 101 includes an optical scanning device 1, a development device 2, a photoreceptor drum 3, a drum cleaning device 4, a charger 5, an intermediate transfer belt device 70, a transfer device 11 (secondary transfer device), a fixing device 12, a sheet conveying path S, a paper feeding cassette 18, and a sheet discharge tray 141.

The image forming apparatus 100 deals with image data corresponding to a color image made of individual colors of black (K), cyan (C), magenta (M), and yellow (Y), or a monochrome image made of a single color (for example, black). An image former 50 of the image forming apparatus 100 is provided with four sets of the development device 2, four sets of the photoreceptor drum 3, four sets of the drum cleaning device 4, and four sets of the charger 5 that form four types of toner images, with the sets respectively serving as image stations Pa, Pb, Pc, Pd corresponding to the colors black, cyan, magenta, and yellow, respectively.

The charger 5 uniformly charges a front surface of the photoreceptor drum 3 to a predetermined potential. The optical scanning device 1 exposes a front surface of the photoreceptor drum 3 to form an electrostatic latent image. The development device 2 develops the electrostatic latent image on the front surface of the photoreceptor drum 3 to form a toner image on the surface of the photoreceptor drum 3. The drum cleaning device 4 removes and collects a residual toner image on the front surface of the photoreceptor drum 3. With the series of operations described above, the toner images of the respective colors are formed on the front surfaces of the respective photoreceptor drums 3.

The intermediate transfer belt device 70 includes an intermediate transfer roller 6, an intermediate transfer belt 71 having an endless shape, an intermediate transfer driving roller 72, an intermediate transfer driven roller 73, and a cleaning device 9. Four of the intermediate transfer rollers 6 are provided on the inner side of the intermediate transfer belt 71 to form the four types of toner images corresponding to the respective colors. The intermediate transfer rollers 6 transfer the toner images of the respective colors formed on the front surfaces of the photoreceptor drums 3 to the intermediate transfer belt 71 that rotates in a rotation direction C.

The intermediate transfer belt 71 is stretched over the intermediate transfer driving roller 72 and the intermediate transfer driven roller 73. In the image forming apparatus 100, the toner images of the respective colors formed on the front surfaces of the respective photoreceptor drums 3 are sequentially transferred and superimposed on the front surface of the intermediate transfer belt 71 to form color toner images on the front surface of the intermediate transfer belt 71.

In the transfer device 11, a transfer nip TN is formed between a secondary transfer roller 11a and the intermediate transfer belt 71, and the recording material P conveyed along the sheet conveying path S is conveyed while being nipped at the transfer nip TN. When the recording material P passes through the transfer nip TN, the toner image on the front surface of the intermediate transfer belt 71 is transferred by the transfer device 11 onto the recording material P. Thus, the recording material P is conveyed to the fixing device 12. The cleaning device 9 removes and collects waste toner that is not transferred onto the recording material P and remains on the surface of the intermediate transfer belt 71.

The fixing device 12 includes the fixing belt 31 (an example of a fixing member) and a pressure roller 32 that rotate while nipping the recording material P. In the fixing device 12, the recording material P onto which the toner image is transferred is nipped at a fixing nip FN between the fixing belt 31 and the pressure roller 32, and is subjected to heat and pressure. With this, the toner image is fixed onto the recording material P. Note that, although not illustrated in FIG. 1, the fixing device 12 includes components other than the fixing belt 31 and the pressure roller 32. Details of the fixing device 12 are described below.

The paper feeding cassette 18 is a cassette for storing the recording material P to be used for image formation, and is provided below the optical scanning device 1. The recording material P is pulled out from the paper feeding cassette 18 by pickup rollers 16, and is conveyed to the sheet conveying path S. The recording material P conveyed to the sheet conveying path S is conveyed to discharge rollers 17 via the transfer device 11 and the fixing device 12, and is discharged to the sheet discharge tray 141 at a discharge portion 140. Conveying rollers 13, registration rollers 14, and the discharge rollers 17 are arranged along the sheet conveying path S. The conveying rollers 13 assist the conveyance of the recording material P. The registration rollers 14 temporarily stop the recording material P, and align a leading edge of the recording material P. The registration rollers 14 convey the temporarily stopped recording material P in synchronization with the timing of the toner image on the intermediate transfer belt 71.

Note that, in the example illustrated in FIG. 1, the number of the paper feeding cassettes 18 is two. However, the number is not limited thereto, and one, three or more paper feeding cassettes 18 may be provided.

When the image forming apparatus 100 forms an image on both the front surface and the back surface of the recording material P, the recording material P is conveyed in the reverse direction from the discharge roller 17 to a sheet reverse path Sr. The image forming apparatus 100 reverses the front and back of the recording material P conveyed in the reverse direction, and guides the recording material P again to the registration rollers 14. The image forming apparatus 100 forms an image on the back surface of the recording material P guided to the registration roller 14 in a similar manner to when forming an image on the front surface, and discharges the recording material P to the sheet discharge tray 141.

### Fixing Device

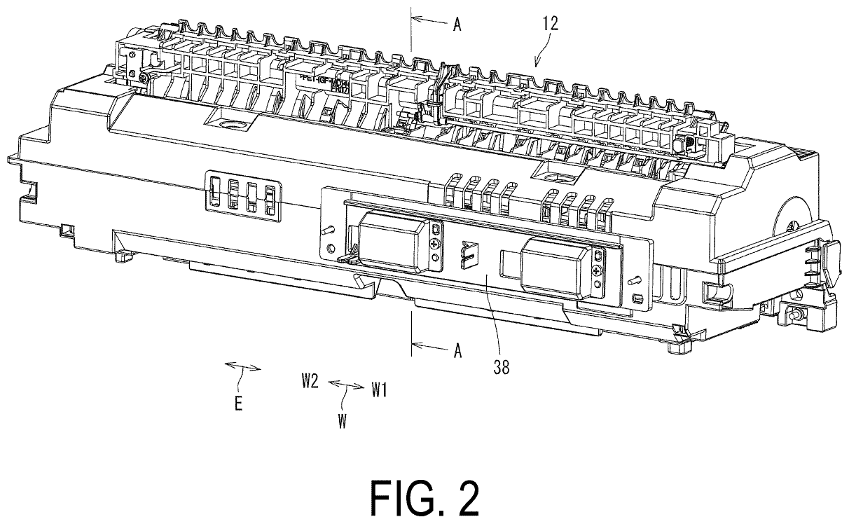

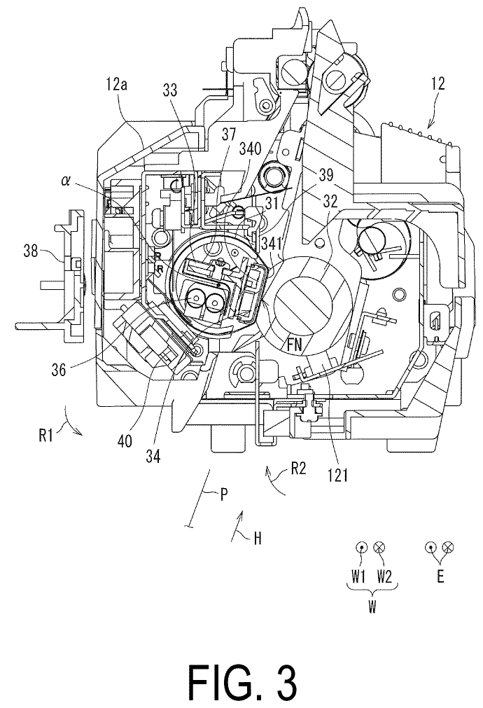

FIG. 2 is a perspective view of the fixing device 12 in the image forming apparatus 100 illustrated in FIG. 1. FIG. 3 is a cross-sectional view taken along the line A-A illustrated in FIG. 2.

The fixing device 12 further includes a supporting member 33, a fixing pad 34, a heat source 36, a reflection member 37 (in this case, a reflection plate), a fixing member temperature detector 38 (a fixing belt temperature sensor, a thermopile in this example), a separation plate 39, a thermostat 40, and a pressure roller temperature detector 121 (a pressure roller temperature sensor, a thermistor in this case). The supporting member 33, the fixing pad 34, the heat source 36, and the reflection member 37 are provided inside the fixing belt 31. The fixing belt 31 is an endless (ring-like) flexible belt. The fixing belt 31 is rotatable about a rotation axis direction α along a width direction E orthogonal to a conveying direction H of the recording material P.

The fixing pad 34 is formed of a resin, and is formed to have a long plate-like shape extending in a rotation axis direction W of the fixing belt 31, for example. The fixing pad 34 includes a fixing pad main body 340 and a slide movement sheet 341 that is provided on the surface of the fixing pad main body 340 on the side that makes sliding contact with the fixing belt 31. A resin material having heat resistance is preferably used as the fixing pad 34, and a heat-resistant resin material having heat resistance such as liquid crystal polymer (LCP) or PEEK (polyether ether ketone) can be used, for example.

The supporting member 33 is a member that supports the fixing pad 34. The supporting member 33 is fixed to a fixing device main body 12a (main body frame) at both end portions in the rotation axis direction W. The reflection member 37 is provided on at least the surface of the supporting member 33 on the heat source 36 side.

The heat source 36 is a member for heating the fixing belt 31, and extends in the rotation axis direction W of the fixing belt 31. The heat source 36 may be a lamp heater such as a halogen lamp, for example. The fixing belt 31 is heated by the heat source 36 to a predetermined fixing temperature (for example, 150° C. to 200° C., 150° C. in this case). Therefore, in addition to the fixing belt 31, the slide movement sheet 341 and the like also have heat resistance with respect to the above-mentioned temperature.

The reflection member 37 is arranged so that at least the surface of the supporting member 33 on the heat source 36 side is covered, and is formed of a metal member having a thin plate-like shape in this example. With this, the fixing belt 31 can be heated efficiently. The reflection member 37 is fixed to the supporting member 33.

The pressure roller 32 is arranged at a position facing the fixing pad 34 with the fixing belt 31 therebetween. The pressure roller 32 rotates in a second rotation direction R2 about a rotation axis line parallel to the rotation axis direction α of the fixing belt 31, and extends parallel to the fixing belt 31. The pressure roller 32 presses the fixing belt 31 toward the fixing pad 34, and forms a fixing nip FN between the pressure roller 32 and the fixing belt 31. The pressure roller 32 can be constituted by a roller member in which, for example, a surface of a cylindrical core formed of a metal such as aluminum is covered with an elastic material such as rubber. The outer diameter of the pressure roller 32 is, but not limited to, 30 mm in this example.

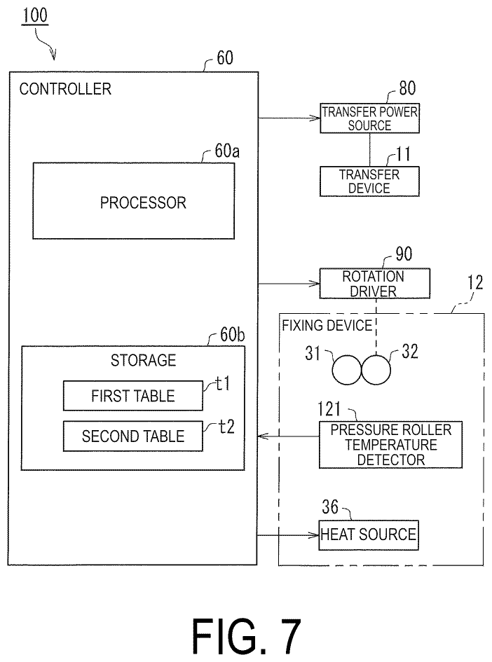

A driving force from a rotation driver 90 such as a motor (see FIG. 7 described below) is transmitted to the pressure roller 32 via a driving force transmission mechanism such as a gear (omitted in illustration). The pressure roller 32 is driven to rotate with a driving force from the rotation driver 90. The fixing belt 31 rotates to follow the rotation of the pressure roller 32 in a first rotation direction R1 that is opposite to the second rotation direction R2 of the pressure roller 32. In other words, the pressure roller 32 abuts against the surface of the fixing belt 31, and thus forms the fixing nip FN. The pressure roller 32 transmits a driving force to the fixing belt 31 via the fixing nip FN, and the fixing belt 31 is driven to rotate.

The fixing member temperature detector 38 detects a surface temperature of the fixing belt 31. In the fixing device 12, temperature control of the heat source 36 is executed based on a detection signal indicating the detection temperature by the fixing member temperature detector 38 so that the fixing belt 31 is at the fixing temperature (150° C. in this case). In this example, the fixing member temperature detector 38 is fixed to the image forming apparatus main body 101 (main body frame) (see FIG. 1). The fixing member temperature detector 38 detects the surface temperature of the fixing belt 31 in a non-contact manner.

The separation plate 39 is arranged in the vicinity downstream of the fixing nip FN in the first rotation direction R1 of the fixing belt 31, and prevents the recording material P from being wound about the fixing belt 31.

The thermostat 40 shuts off power supply to the heat source 36 when the heat source 36 performs abnormal heating. Specifically, the thermostat 40 is electrically connected to a power (omitted in illustration) that supplies power source to the heat source 36, and directly shuts off power supply to the heat source 36. The thermostat 40 is fixed to the fixing device main body 12a (main body frame). When a predetermined reaction temperature (an operation temperature, a rated temperature) is reached, the thermostat 40 is operated to shut off power supply to the heat source 36.

The pressure roller temperature detector 121 detects a surface temperature of the pressure roller 32. In this example, the pressure roller temperature detector 121 is fixed to the fixing device main body 12a (main body frame) while being separated from the surface of the pressure roller 32. The pressure roller temperature detector 121 detects a surface temperature in a passing region of the pressure roller 32 (in this example, a center region in a rotation axis direction W of the fixing belt 31) through which the recording material P passes, in a non-contact manner.

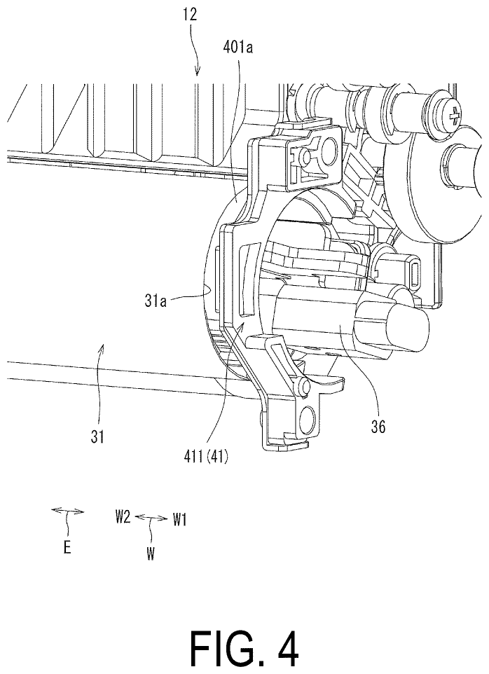

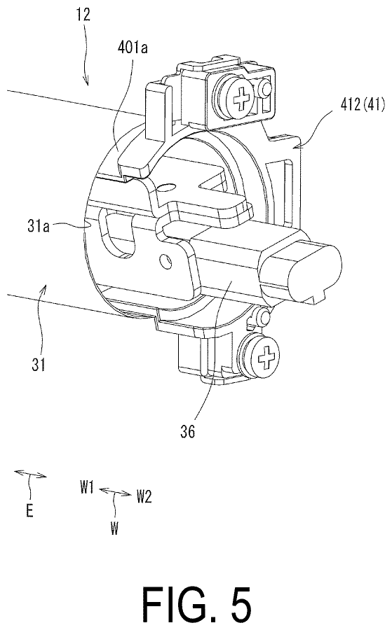

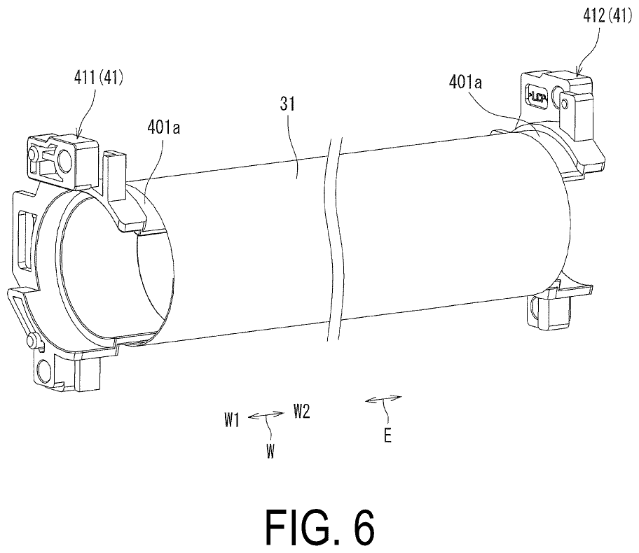

FIG. 4 and FIG. 5 are perspective views of parts corresponding to end portions of the fixing device 12 according to the present embodiment on one side W1 and the other side W2 in the rotation axis direction W of the fixing belt 31 as viewed from the front side and the back side, respectively. FIG. 6 is a perspective view of a state in which the fixing belt 31 is supported by one holding member 411 and the other holding member 412 as viewed from the front side.

As illustrated in FIG. 4 and FIG. 6, the fixing device 12 includes the pair of holding members 411 and 412 (41) (belt guide member) and the fixing belt 31 that is provided on an outer circumferential surface 401a of the pair of holding members 411 and 412 (41) so as to be rotatable about the rotation axis direction α (see FIG. 3). The pair of holding members 411 and 412 (41) are fixed to the fixing device main body 12a (main body frame) (see FIG. 3).

The pair of holding members 411 and 412 (41) support both end portions of an inner surface 31a of the fixing belt 31 in the rotation axis direction W. Of the pair of holding members 411 and 412 (41), the one holding member 411 holds the end portion of the inner surface 31a of the fixing belt 31 on one side W1 (a front side, an operation side) in the rotation axis direction W, and the other holding member 412 holds the end portion of the inner surface 31a of the fixing belt 31 on the other side W2 (rear side) in the rotation axis direction W.

### Control Configuration

FIG. 7 is a schematic block diagram illustrating a control configuration for deciding a circumferential speed of the pressure roller 32, based on the surface temperature of the fixing belt 31 and the surface temperature of the pressure roller 32 in the image forming apparatus 100. The image forming apparatus 100 includes a controller 60, the transfer device 11, a transfer power source 80, the fixing device 12, and the rotation driver 90.

The controller 60 controls the entirety of the image forming apparatus 100. As illustrated in FIG. 7, the controller 60 includes a processor 60a implemented by a central processing unit (CPU) or a system on a chip (SoC) and a storage 60b including a nonvolatile memory such as a read only memory (ROM) and a volatile memory such as a random access memory (RAM). The controller 60 may include one or a plurality of control circuits. Further, the storage 60b may include one or a plurality of storages. The processor 60a loads a control program stored in advance in the ROM of the storage 60b onto the RAM of the storage 60b, and executes the control program. With this, the controller 60 executes operation control of various constituent elements. The storage 60b stores a first table t1 and a second table t2. Those two types of tables are used in circumferential speed decision processing for the pressure roller 32 by the processor 60a, which is described below.

The transfer device 11 executes transfer processing for transferring a toner image formed on the photoreceptor drum 3 onto the recording material P. The configuration of the transfer device 11 is as described above, and the description is omitted herein.

The transfer power source 80 supplies a transfer vial being a predetermined voltage or current to the transfer device 11. As illustrated in FIG. 7, the transfer power source 80 is electrically connected to an input system of the controller 60. With this, the controller 60 can execute operation control for the transfer power source 80 by transmitting a transfer power source operation control signal to the transfer power source 80. An output terminal of a power system in the transfer power source 80 is electrically connected to the transfer device 11. With this, the transfer power source 80 can supply a transfer bias to the transfer device 11 under an instruction of the controller 60.

The fixing device 12 heats a toner image transferred onto the recording material P, and fixes the toner image onto the recording material P by the fixing member (the fixing belt 31 in this example) and the pressure roller 32. The configuration of the fixing device 12 is as described above, and the description is omitted herein. As illustrated in FIG. 7, the pressure roller temperature detector 121 included in the fixing device 12 is electrically connected to the input system of the controller 60. With this, the controller 60 can detect a detection temperature (surface temperature) of the pressure roller 32, based on the detection signal transmitted from the pressure roller temperature detector 121. The heat source 36 included in the fixing device 12 is electrically connected to an output system of the controller 60. With this, the controller 60 can execute operation control for the heat source 36 by transmitting a heat source operation control signal to the heat source 36.

The rotation driver 90 transmits a driving force to the pressure roller 32 included in the fixing device 12 via a driving force transmission mechanism such as a gear (omitted in illustration). As illustrated in FIG. 7, the rotation driver 90 is electrically connected to the output system of the controller 60. With this, the controller 60 can execute operation control for the rotation driver 90 by transmitting a rotation driver operation control signal to the rotation driver 90.

### First Embodiment

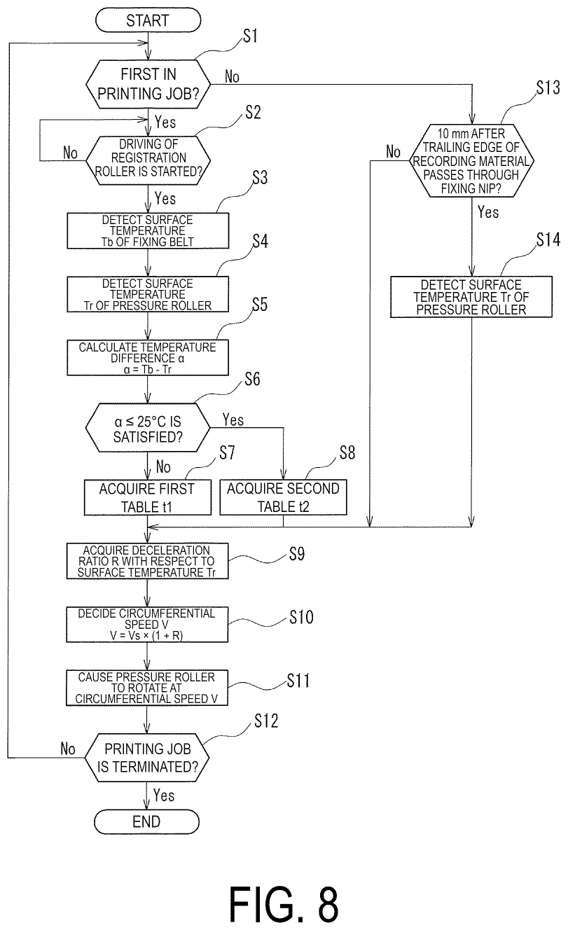

Next, a first embodiment of the present disclosure is described. The first embodiment is characterized in that a thermal expansion degree in a radial direction of the pressure roller 32, based on a temperature difference between the surface temperature of the fixing belt 31 and the surface temperature of the pressure roller 32 (corresponding to a “parameter” according to the present disclosure). FIG. 8 is a flowchart illustrating a flow of the circumferential speed decision processing for the pressure roller 32 by the processor 60a of the controller 60.

When the circumferential speed decision processing for the pressure roller 32 is started, the processor 60a first determines whether a first recording material P in a printing job is subjected to printing to be executed (Step S1). As a result, when it is determined that printing is to be executed for the first recording material P (S1: Yes), the processor 60a determines whether driving of the registration rollers 14 is started, in other words, the conveyance of the recording material P toward the transfer device 11 is started (Step S2). Note that, in the present embodiment, the start of the printing job is detected based on the timing at which driving of the registration rollers 14 is started. However, the method of detecting the start of the printing job is not limited thereto. For example, the detection may be based on a timing at which the recording material P is fed out from the document placement tray 161 or a timing at which the recording material P is picked up from the paper feeding cassette 18.

As a result of the determination in Step S2, when it is determined that driving of the registration rollers 14 is not started (S2: No), the processor 60a returns to Step S2, and repeats the determination until driving of the registration rollers 14 is started. In contrast, as a result of the determination in Step S2, when it is determined that driving of the registration rollers 14 is started (S2: Yes), the processor 60a detects a surface temperature Tb of the fixing belt 31 by executing operation control for the fixing member temperature detector 38 (Step S3). Subsequently, the processor 60a detects a surface temperature Tr of the pressure roller 32 by executing operation control for the pressure roller temperature detector 121 (Step S4). Note that Step S3 and Step S4 may be executed in the order opposite to that in the present embodiment.

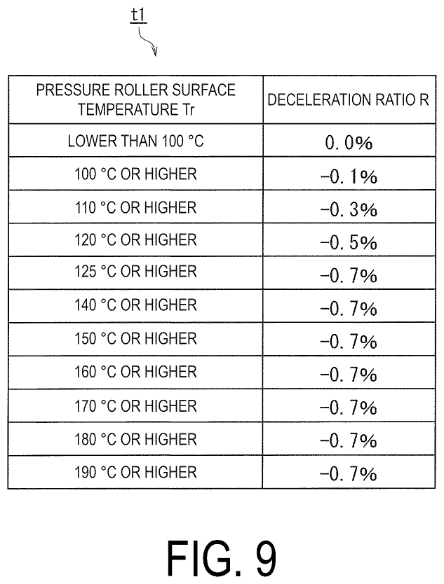

Subsequently, the processor 60a calculates a temperature difference α between the surface temperature Tb of the fixing belt 31 and the surface temperature Tr of the pressure roller 32 by solving the equation α=Tb−Tr (Step S5). In other words, calculation is executed. Then, the processor 60a determines whether the temperature difference α being calculated is equal to or lower than 25° C. (Step S6). As a result, when it is determined that the temperature difference α has a magnitude exceeding 25° C. (α>25° C.) (S6: No), the processor 60a acquires the first table t1 stored in advance from the storage 60b included in the controller 60 (Step S7). FIG. 9 is an explanatory view illustrating the first table t1 according to the present embodiment. In the first table t1, the surface temperature Tr of the pressure roller 32 and a deceleration ratio R from a reference circumferential speed Vs of the pressure roller 32 are associated with each other in a one-on-one manner, and are displayed. In the present embodiment, the reference circumferential speed Vs of the pressure roller 32 is set to be a circumferential speed of the pressure roller 32 when the surface temperature Tr of the pressure roller 32 is a normal temperature (less than 100° C.). Therefore, in the first table t1, the deceleration ratio R is set to 0% when the surface temperature Tr is lower than 100° C., and the deceleration ratio R is set to be gradually reduced as the surface temperature Tr rises from 100° C. to around 125° C. In the first table t1, when the surface temperature Tr is equal to or higher than 125° C., the deceleration ratio R is set to be constant at −0.7%. Note that, in Step S6, the threshold value used for the determination is not limited to 25° C., and may be set to any value. The setting mode of the first table t1 is not limited to the present embodiment, and may be changed freely.

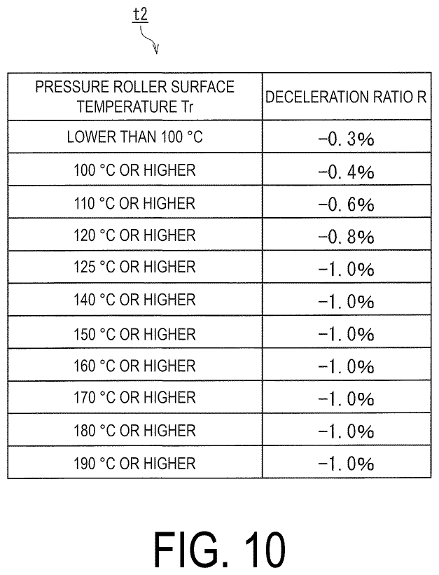

In contrast, as a result of the determination in Step S6, when it is determined that the temperature difference α being calculated is equal to or less than 25° C. (α≤25° C.) (S6: Yes), the processor 60a acquires the second table t2 being stored in advance from the storage 60b (Step S8). FIG. 10 is an explanatory view illustrating the second table t2 according to the present embodiment. Similarly to the first table t1, in the second table t2, the surface temperature Tr of the pressure roller 32 and the deceleration ratio R from the reference circumferential speed Vs of the pressure roller 32 are also associated with each other in a one-on-one manner, and are also displayed. However, in the second table t2, the deceleration ratio R with respect to the surface temperature Tr of the pressure roller 32 is set so that the deceleration degree from the reference circumferential speed Vs is greater, in other words, an absolute value of the deceleration ratio R is greater as compared to the first table t1. In the present embodiment, the deceleration ratio R in the second table t2 is set so as to be reduced by 0.3%, in other words, so as to be increased by 0.3% in an absolute value as compared to the deceleration ratio R corresponding to the same surface temperature Tr in the first table t1. Note that the extent to which the deceleration degree in the second table t2 is set greater than that in the first table t1 is not limited to the present embodiment, and may be set freely.

Subsequently, the processor 60a refers to the first table t1 or the second table t2 being acquired, and thus acquires the deceleration ratio R of the pressure roller 32 corresponding to the surface temperature Tr of the pressure roller 32 that is detected in Step S4 (Step S9). Then, the processor 60a decides a circumferential speed V of the pressure roller, based on the deceleration ratio R being acquired (Step S10). Specifically, the processor 60a decides the circumferential speed V of the pressure roller by solving the equation V=Vs×(1+R). Then, the processor 60a causes the pressure roller 32 to rotate at the circumferential speed V being decided (Step S11).

After that, the processor 60a determines whether the printing job is terminated (Step S12). As a result, when it is decided that the printing job is terminated (S12: Yes), the processor 60a terminates the circumferential speed decision processing for the pressure roller 32. In contrast, it is determined that the printing job is not terminated yet (S12: No), the processor 60a returns to Step S1, and determines whether the first recording material P in the printing job is subjected to printing to be executed subsequently. As a result, when it is determined that the second or subsequent recoding material P is subjected to printing (S1: No), the processor 60a determines whether a conveyance distance after the trailing edge of the recording material P passes through the fixing nip FN reaches 10 mm (Step S13).

As a result of the determination in Step S13, when it is determined that the conveyance distance after the trailing edge of the recording material P passes through the fixing nip FN does not reach 10 mm (S13: No), the processor 60a proceeds to Step S9, and acquires the deceleration ratio R of the pressure roller 32 corresponding to the surface temperature Tr of the pressure roller 32 that is detected in Step S4. After that, the processing is executed similarly as described above. In contrast, as a result of the determination in Step S13, it is determined that the conveyance distance reaches 10 mm (S13: Yes), the processor 60a detects the surface temperature Tr of the pressure roller 32 by controlling the operation of the pressure roller temperature detector 121 (Step S14). Note that, with regard to the second or subsequent recoding material P, the timing at which the surface temperature Tr of the pressure roller 32 is detected is not limited to the present embodiment. For example, the determination may be executed based on an elapse time after the trailing edge of the recording material P passes through the fixing nip FN.

Subsequently, the processor 60a proceeds to Step S9, refers to the first table t1 or the second table t2 being acquired previously to acquire the deceleration ratio R of the pressure roller 32 corresponding to the surface temperature Tr of the pressure roller 32 that is detected in Step S14. After that, the processor 60a proceeds to Step S10, and the processing is repeated similarly as described above.

In this manner, according to the circumferential speed decision processing for the pressure roller 32 according to the present embodiment, at the start of the printing job, the processor 60a calculates the temperature difference α of the surface temperature Tb of the fixing belt 31 and the surface temperature Tr of the pressure roller 32, and estimates the thermal expansion degree in the radial direction of the pressure roller 32, based on the temperature difference α. In other words, when the temperature difference α has a magnitude exceeding 25° C., the processor 60a determines that the surface temperature Tr of the pressure roller 32 is relatively low and the pressure roller 32 has not thermally expanded yet. In this case, the processor 60a decides the circumferential speed V of the pressure roller 32 to be a relatively high speed, based on the first table t1. In contrast, when the temperature difference α is equal to or lower than 25° C., the processor 60a determines that the surface temperature Tr of the pressure roller 32 is relatively high, and the pressure roller 32 thermally expands to some extent. In this case, the processor 60a decides the circumferential speed V of the pressure roller 32 to be a relatively low speed, based on the second table t2. Therefore, while the pressure roller 32 thermally expands, and the conveying force of the recording material P is increased, the circumferential speed V is set to be relatively low. With this, the conveying speed of the recording material P in the fixing device 12 is kept constant. With this, a deflection amount of the recording material P is kept constant between the transfer device 11 and the fixing device 12. Thus, the above-mentioned problem of the transfer failure caused by the recording material P in a state with less deflection can be prevented in advance.

### Second Embodiment

Next, the second embodiment of the present disclosure is described. The second embodiment is characterized in that an index different from the temperature difference between the surface temperature Tb of the fixing belt 31 and the surface temperature Tr of the pressure roller 32 is used as a method of estimating the thermal expansion degree in the radial direction of the pressure roller 32, in other words, an index different from that in the first embodiment is used as the “parameter” according to the present disclosure. As the parameter, for example, an internal temperature of the pressure roller 32, a temperature difference between the surface temperature Tr and the internal temperature of the pressure roller 32, a temperature of the heat source 36, a temperature difference between the temperature of the heat source 36 and the surface temperature Tr of the pressure roller 32, the surface temperature Tb of the fixing belt 31, and the like may be used. Note that the matters other than changing of the parameter are similar to those in the first embodiment, and hence the description is omitted herein.

### Third Embodiment

Next, the third example of the present disclosure is described. The third embodiment is characterized in that processing of the circumferential speed V of the pressure roller 32 by referring to three or more tables indicating a correspondence between the surface temperature Tr of the pressure roller 32 and the circumferential speed V of the pressure roller 32. For example, although details are omitted in illustration, three tables, specifically, a first table, a second table, and a third table that indicate different correspondences relating to the surface temperature Tr of the pressure roller 32 and the circumferential speed V of the pressure roller 32 are stored in advance in the storage 60b. Then, the processor 60a acquires the first table when the temperature difference α between the surface temperature Tb of the fixing belt 31 and the surface temperature Tr of the pressure roller 32 is less than a first threshold value, acquires the second table when the temperature difference α is equal to or more than the first threshold value and equal to or less than a second threshold value, and acquires the third table when the temperature difference α is more than the second threshold value. After that, the processor 60a refers to the table being acquired to decide the circumferential speed V of the pressure roller 32. As a matter of course, the number of tables stored in the storage 60b may be four or more. Note that the embodiment is similar to the first embodiment except for the number of tables, and hence the description is omitted herein.

The image forming apparatus according to the present disclosure can be applied not only as a so-called multifunction machine but also as a dedicated machine only including a copy function, a facsimile function, or a printer function.

1. An image forming apparatus that forms an image being a toner image on a recording material having a sheet-like shape, the image forming apparatus comprising:
a transfer device that causes a recording material to be nipped between a transfer nip and transfers a toner image onto the recording material;
a fixing device that causes a recording material to be nipped between a fixing nip and fixes the toner image on the recording material, the fixing device including:
a fixing member that is axially supported to be rotatable;
a heat source that heats the fixing member;
a pressure roller that forms the fixing nip together with the fixing member and is driven to rotate; and
a pressure roller temperature detector that detects a surface temperature of the pressure roller;
a storage that stores, for each thermal expansion degree in a radial direction of the pressure roller, a table showing a correspondence between the surface temperature of the pressure roller and an appropriate circumferential speed of the pressure roller; and
a processor that estimates, at a start of a printing job, a thermal expansion degree in the radial direction of the pressure roller, based on a parameter different from the surface temperature of the pressure roller, acquires the table from the storage, based on the estimation, refers to the table being acquired to decide a circumferential speed of the pressure roller that corresponds to the surface temperature of the pressure roller that is detected by the pressure roller temperature detector.

2. The image forming apparatus according to claim 1, wherein
the fixing device includes a fixing member temperature detector that detects a surface temperature of the fixing member, and
the parameter is a temperature difference between a surface temperature of the fixing member that is detected by the fixing member temperature detector and the surface temperature of the pressure roller that is detected by the pressure roller temperature detector.

3. The image forming apparatus according to claim 2, wherein
the storage stores a first table to be acquired when the temperature difference exceeds a predetermined threshold value and a second table to be acquired when the temperature difference is equal to or less than the predetermined threshold value.

4. The image forming apparatus according to claim 3, wherein
the first table associates the surface temperature of the pressure roller with the circumferential speed of the pressure roller so that the circumferential speed of the pressure roller is reduced to be lower than a reference circumferential speed when the surface temperature of the pressure roller is at a predetermined temperature higher than 10 a normal temperature, the reference circumferential speed being defined as the circumferential speed of the pressure roller when the surface temperature of the pressure roller is at the normal speed.

5. The image forming apparatus according to claim 4, wherein
the second table associates the surface temperature of the pressure roller with the circumferential speed of the pressure roller so that the circumferential speed of the pressure roller is reduced to be lower than the reference circumferential speed, and the reduction degree is larger than that in the first table when the surface temperature of the pressure roller is a predetermined temperature higher than the normal temperature.

6. The image forming apparatus according to claim 1, wherein
the printing job is started at a timing at which a registration roller feeds a first recording material to the transfer device.

7. The image forming apparatus according to claim 1, wherein
the processor acquires the surface temperature of the pressure roller from the pressure roller temperature detector at a predetermined timing after the printing job is started, and refers to the table being acquired to decide the circumferential speed of the pressure roller again.

8. The image forming apparatus according to claim 7, wherein
the predetermined timing after the printing job is started is a timing at which a trailing end of each of second and subsequent recording materials is conveyed forward by 10 mm after the trailing end passes through the transfer nip.
